(19) United States
(12) Patent Application Publication
(10) Pub. No.: US 2025/0242548 A1
(43) Pub. Date: Jul. 31, 2025

(54) MACHINE FOR ULTRASONIC WELDING AND METHOD FOR ULTRASONIC WELDING

(71) Applicant: Magna Exteriors (Bohemia) s.r.o., Liberec (CZ)

(72) Inventor: Radim ŽDÁRSKÝ, Liberec (CZ)

(21) Appl. No.: 19/014,509

(22) Filed: Jan. 9, 2025

(30) Foreign Application Priority Data
Jan. 26, 2024 (DE) 102024200700.5

(51) Int. Cl. B29C 65/08; B29C 65/78

(52) U.S. Cl. CPC B29C 65/085; B29C 65/7841

(57) ABSTRACT

A machine for ultrasonic welding having at least one guided welding horn, wherein a sonotrode tool is held on a holder at the zero point of the sonotrode tool and is guided along a weld seam to be produced, and wherein the holder also forms a support for a spray nozzle which is mounted at an acute angle to the sonotrode tool.

### CROSS-REFERENCE TO RELATED APPLICATIONS

This application claims the benefit of and priority to German Patent Application No. DE 102024200700.5 filed on Jan. 26, 2024. The entire disclosure of the above application is incorporated herein by reference.

### FIELD OF THE INVENTION

The invention relates to a machine for ultrasonic welding having at least one guided welding horn, wherein a sonotrode tool is held on a holder of the sonotrode tool and is guided along a weld seam to be produced.

The invention also relates to a method for ultrasonic welding.

### BACKGROUND OF THE INVENTION

This section provides information related to the present disclosure which is not necessarily prior art.

Ultrasonic welding is a method for joining plastics in which mechanical vibrations above the limit of audibility are used. The frequency range of ultrasonic vibrations is approximately between 20 KHz and 1 GHz. Mechanical vibrations in the ultrasonic frequency range are often generated from electric energy by means of piezoelectric converters.

The resulting mechanical vibrational energy is applied to the material to be processed by means of a sonotrode connected to the converter, optionally via an amplitude transformation piece, a booster. In this case, the sonotrode is in direct contact with the material to be processed and transmits the generated mechanical vibrations to the latter under pressure.

The task of the amplitude transformation piece is to adapt the vibration amplitude provided by the converter to the requirements of the material to be processed and to transmit these vibrations to the sonotrode. The surface of the sonotrode which is intended to come into contact with the material to be processed is also referred to as a sealing surface.

A sonotrode is thus part of a structure that vibrates during operation, consisting of a converter, optionally an amplitude transformation piece, and the sonotrode. This vibrating structure is also referred to as an ultrasonic vibrational unit. To make it possible to ensure effective transfer of the ultrasonic vibrations by means of an ultrasonic vibrational unit to a material to be processed, it is necessary for the ultrasonic vibrational unit to be brought into resonance. Depending on its construction, the ultrasonic vibrational unit generally has a large number of different natural frequencies. Resonant vibration of the ultrasonic vibrational unit can only be brought about if the converter generates a natural frequency of the ultrasonic vibrational unit. For this reason, the converter and the ultrasonic vibrational unit must be matched to one another.

During ultrasonic welding, the material to be processed is generally inserted between the sonotrode and a corresponding mating tool, the anvil, which does not belong to the ultrasonic vibrational unit. The ultrasound energy is transmitted from the sonotrode to the material to be processed via the sealing surface. During this process the ultrasonic vibrations are converted into frictional energy, thereby generating heat, which leads to the plasticization of the processed material. This thermal plasticization is caused by friction between boundary surfaces and molecules.

The production of such a welded joint is particularly critical when a Class-A surface for motor vehicle construction is involved. The weld seam must not be visible on the Class-A surface.

The expression “Class A” refers to visible free-form surfaces on the exterior and interior of vehicles. “Class B” surfaces are understood to mean internal surfaces of Class-A surfaces that are not visible to the user, as well as the load-bearing structure of an object.

DE 42 06 584 A1 relates to a device for processing a component or connecting two components by means of ultrasound using an ultrasound generator and an ultrasound installation, wherein the ultrasound installation has an ultrasonic welding device with a converter and a sonotrode. In addition, the invention relates to a method for connecting two components by means of ultrasound, in which an ultrasound generator imparts vibration to a sonotrode via a converter. Furthermore, the ultrasound installation is provided with a cooling device, by means of which the welding location and/or the sonotrode tip are/is cooled. The cooling device is designed as a single blowing nozzle or as an annular nozzle surrounding the sonotrode tip.

### SUMMARY OF THE INVENTION

This section provides a general summary of the disclosure, and is not a comprehensive disclosure of its full scope or all of its features.

It is the object of the invention to achieve a watertight joint between plastic components, wherein the Class-A surface remains unaffected.

The object is achieved by means of a machine for ultrasonic welding having at least one guided welding horn of a sonotrode tool, wherein the sonotrode tool is held on a holder of the sonotrode tool and is guided along a weld seam to be produced, wherein the holder also forms a support or holder for a spray nozzle, which is mounted at an acute angle to the sonotrode tool and applies a fluid.

The welding horn and the spray nozzle are guided jointly over the components to be welded. The term “spray nozzle” also includes a liquid applicator and a compressed air outlet.

A rolling/pushing tool optionally follows the welding horn during the welding process.

The welding horn preferably has a simple spherical tip.

The spray nozzle is connected to a reservoir for a fluid.

The object is also achieved by means of a method for welding plastic components using a machine, wherein the spray nozzle forms a spray mist which wets the surface of the plastic components in the region of the weld seam to be produced.

The spray mist is formed by a soapy aqueous solution.

The quantity of spray mist is set in such a way that the liquid completely evaporates during the welding process.

The continuous welding process allows parts of any size to be welded, with a high degree of freedom in terms of shape, using a simple and low-cost welding tool, a sonotrode. It eliminates the need for a large and expensive ultrasonic probe or an alternative, expensive and complicated welding method, e.g. laser welding. It produces not only a strong weld seam but also a watertight weld seam, and it can therefore be used as a replacement for adhesive bonding in many applications, and it also replaces spot welding, in which water tightness can be achieved only with an additional seal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows schematically a machine for ultrasonic welding in the prior art,

FIG. 2 shows the structure of a machine according to the invention,

FIG. 3 shows a sonotrode tool.

### DESCRIPTION OF THE INVENTION

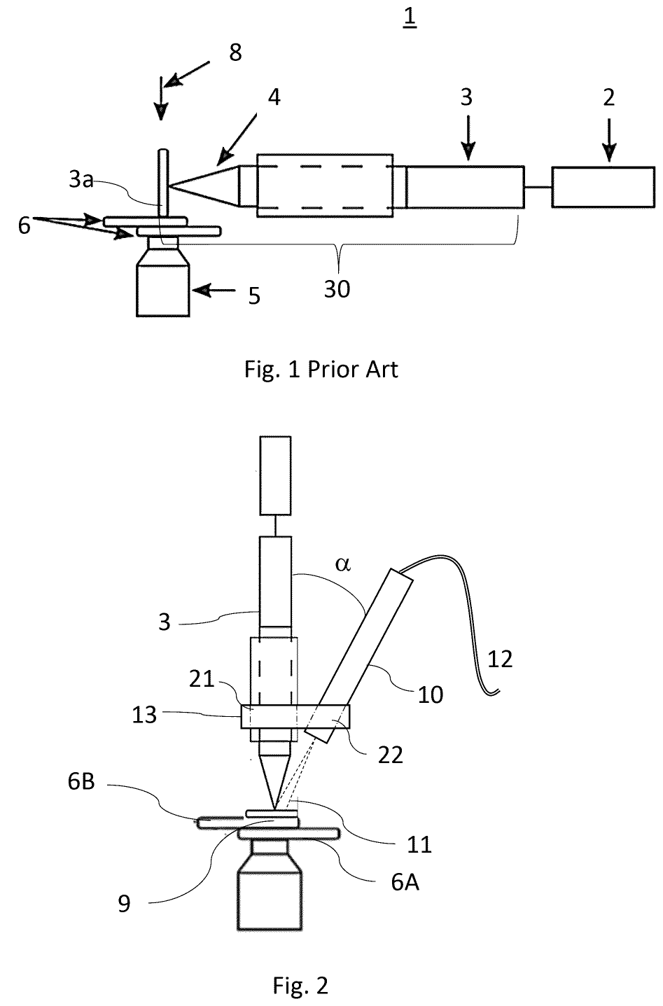

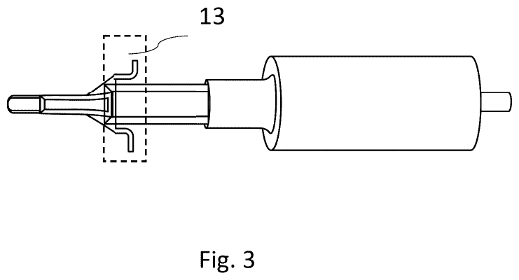

FIG. 1 shows an example from the prior art. A machine press or a robot arm holds the actual welding system and exerts the force which holds the welded joint together, this being illustrated schematically as an arrow 8. It has a manometer and a controller, enabling the operator to set the force exerted on the system.

In this example, the welding stack comprises the transducer 2, the amplifier 3 and the welding horn 4, which are all mounted on the machine press via a central point of the amplifier 3.

A transducer 2 or converter converts high-frequency electric energy into mechanical vibrations.

The booster or amplifier 3 has two functions. First of all, it amplifies the generated vibrations by contraction and expansion and transmits them to the welding horn 4.

The welding horn 4 is responsible for transmitting the vibration to the welded part. It comprises a durable metal such as titanium. To reduce wear, most welding horns 4 have hardened tips. An anvil 5 or some other support is usually arranged under the components 6 to be welded.

A sonotrode tool 30 is understood to mean the booster 3 together with the welding horn 4.

The two workpieces 6 are then welded in the region of the welding horn. Arrow 8 represents the contact force.

The arrangement according to the invention, see FIG. 2, is used for 100% continuous ultrasonic operation during welding in order to produce a watertight weld seam.

The basic structure of the machine according to the invention follows the machine illustrated in FIG. 1, together with its parts, and the basic arrangement.

The components 6A, 6B to be welded are pressed against one another and are secured against slipping or displacement before being welded. During this process, they can be secured mechanically by means of clamps or, alternatively by easily released tacking means. The welding pressure is supplied by the robot arm which guides the sonotrode and thus presses the components 6A, 6B against one another. The use of individual components such as an amplifier is optional, or the functions are integrated into the actual sonotrode tool 30.

To fix the sonotrode 4 on a work table or a robot arm, the sonotrode tool 30 is, in an advantageous embodiment, firmly clamped by means of a holder 13 in the region of its zero-point position, thereby ensuring that the sonotrode tool 30 is fixed in position but positioned on the robot arm in a manner that allows vibration.

The holder 13 is a stable metal or plastic component which grips the sonotrode tool 30 firmly and in a manner secure against slipping. For this purpose, a first opening 21 is provided in the holder 13.

The ultrasonic welding sonotrode is thus held at the zero point, thus enabling higher radial forces to act upon it.

Alternatively, the sonotrode tool 30 may also be held in the central region of the amplifier or of the transducer.

The sonotrode tool 30 is moved continuously over component 6B by means of a robot or manipulator, and the weld to component 6A is thus generated in the contact region between the surface of component 6B and the welding horn 4 by means of the machine for ultrasonic welding. Since the weld seam is now formed at the point of contact between the welding horn 4, to be more precise the tip of the welding horn 4, and component 6, very effective cooling is required.

In a preferred embodiment, water is used for cooling, and this cools component 6B and the welding horn 4 more intensively than would be possible with the ambient air or an air blower alone.

Alternatively to cooling with pure water, a soapy solution is used.

The water or soapy fluid is applied in the region of the weld seam, being directed onto the surface of component 6B and the welding horn 4 in a spray mist 11 via a spray nozzle 10.

A feed line 12 connected to a reservoir or a water connection is used to supply the spray nozzle 10.

The spray nozzle 10 is likewise fixed on the holder 13, wherein the spray nozzle is held at an acute angle α to the sonotrode tool 30. For this purpose, there is a further opening 22 in the holder 13, thus enabling the spray nozzle 10 to be held and guided in a common holder 13 with the sonotrode tool 30. The further opening 22 for the spray nozzle 10 can be a hole extending at an acute angle α through the holder 13, e.g. an annular holder.

The acute angle α is no more than 25°, wherein the spray nozzle 10 does not rest directly against the sonotrode tool 30 but is connected to the sonotrode tool 30 only via the common holder 13.

With the cooling and, where applicable, slightly lubricating liquid mist, continuous ultrasonic welding using a simple welding sonotrode is possible, producing a strong, watertight weld seam without damage and leaving behind no impressions on the components 6B, 6A.

Cooling is thus performed by a fluid.

For harder plastics, which have higher melting points, or in order to achieve higher welding speeds, a rolling/pushing tool is arranged directly after the welding horn 4 in the machine. For this purpose, use is made either of an additional robot arm, which guides this rolling/pushing tool, or, in the case of simple, straight weld seams, of a fixed station in the welding machine installation.

The rolling/pushing tool holds the components 6A, 6B together for a certain time of up to 3 seconds after welding. During this short time and owing to the effect of cooling, the material solidifies again after welding and is locally fully welded.

Only the amount of water and additives that can be evaporated during welding is applied to the component 6B to be welded and to the welding horn 4, and therefore the parts are dry and clean after welding.

The technology can be applied to all plate materials, shapes and sizes and produces a high-quality, watertight weld seam without damage or removal of welding residues on all plate surfaces.

What is claimed is:

1. A machine for ultrasonic welding having at least one guided welding horn, wherein a sonotrode tool is held on a holder of the sonotrode tool and is guided along a weld seam to be produced, wherein a spray nozzle is likewise fixed on the holder for the sonotrode tool, which nozzle is mounted at an acute angle to the sonotrode tool and applies a fluid consisting of water or a soapy aqueous solution directed at the weld seam, and wherein the spray nozzle is connected to a reservoir or a water connection for the fluid.

2. The machine according to claim 1, wherein the welding horn and the spray nozzle are guided jointly over the components to be welded.

3. The machine according to claim 1, wherein a rolling/pushing tool follows the welding horn and holds the parts together for a certain time after welding.

4. The machine according to claim 1, wherein the welding horn has a simple spherical tip.

5. A method for welding plastic components using a machine according to claim 1, wherein the spray nozzle forms a spray mist which wets the surface of the plastic components in the region of the weld seam to be produced.

6. The method for welding plastic components using a machine according to claim 5, wherein the spray mist is formed by a soapy aqueous solution.

7. The method for welding plastic components using a machine according to claim 5, wherein the quantity of spray mist is set in such a way that the liquid completely evaporates during the welding process.
